(19) United States
(12) Patent Application Publication
(10) Pub. No.: US 2013/0303096 A1
(43) Pub. Date: Nov. 14, 2013

(54) WIRELESS HEADPHONES DEVICE

(71) Applicant: Melissa Foster, Saint Louis, MO (US)

(72) Inventor: Melissa Foster, Saint Louis, MO (US)

(21) Appl. No.: 13/467,045

(22) Filed: May 9, 2012

(51) Int. Cl. H04R 1/10; H04B 1/08

(52) U.S. Cl. 455/149

(57) ABSTRACT

The present invention is a wireless headphones device utilized by a user with a head that includes a right headphone that has an exterior cover portion and an interior portion and includes a radio tuner, a volume control button, a display screen, a recharging port, a headband and a first plurality of pads and a left headphone that has an exterior cover portion and an interior portion and includes a SD card insert, a second plurality of pads and a plurality of control buttons, wherein the headband has an inside surface and adjustably places the wireless headphones device over the user's head.

### TECHNICAL FIELD & BACKGROUND

While engaging in various activities such as walking, exercising, relaxing or other similar activities, many individuals enjoy listening to music through portable electronic devices. Conventional headphones are attached to standard music players via wires which can become tangled, worn and can be particularly cumbersome while engaged in physical activities.

The present invention generally relates to a headphones device. More specifically, the invention is a wireless headphones device.

It is an object of the invention to provide a wireless headphones device that can utilize an SD Card, a satellite radio and a USB port.

It is an object of the invention to provide a wireless headphones device that allows a user to download and insert an SD Card while having a capability to listen to a satellite radio station.

It is an object of the invention to provide a wireless headphones device that is relatively more portable and convenient than a traditional headphone device.

What is really needed is a wireless headphones device that can utilize an SD Card, a satellite radio and a USB port that allows a user to download and insert an SD Card while having a capability to listen to a satellite radio station that is relatively more portable and convenient than a traditional headphone device.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a right side view of a wireless headphones device, according to an embodiment of the present invention.

FIG. 1B illustrates a left side view of a wireless headphones device, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

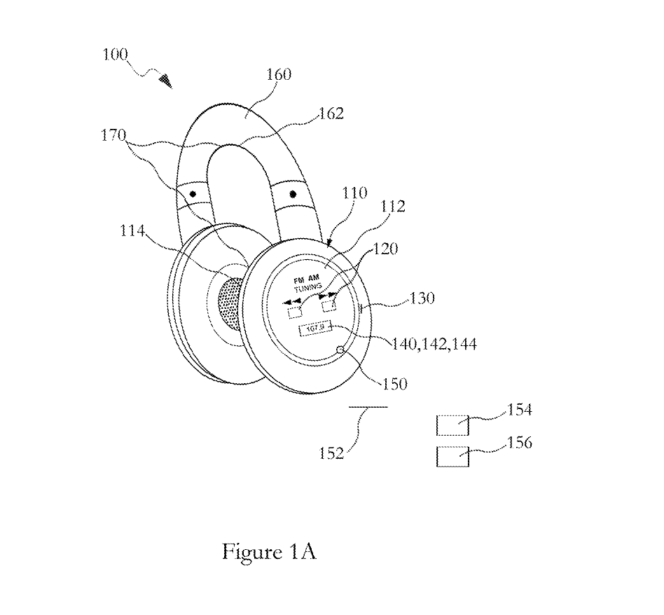

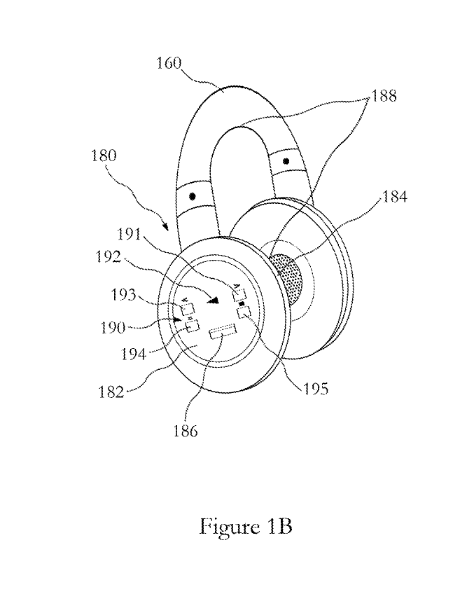

FIG. 1A illustrates a right side view of a wireless headphones device 100, according to an embodiment of the present invention. More specifically, FIG. 1A illustrates a right headphone 110 of the wireless headphones device 100.

The right headphone 110 has an exterior cover portion 112 and an interior portion 114 and includes a radio tuner 120, a volume control button 130, a display screen 140, a recharging port 150, a headband 160 and a first plurality of pads 170. The radio tuner 120 selects one or more predetermined radio stations that can be a satellite radio station, an AM/FM radio station or other suitable radio station. The volume control button 130 controls a plurality of predetermined volume levels of music emitted from the wireless headphones device 100. The display screen 140 indicates the predetermined radio station selected by the wireless headphones device 100. The display screen 140 can be an LED display screen 142, a digital display screen 144 or any other suitable display screen. The recharging port 150 can receive an input jack 152 from an external electrical power source such as a battery 154 or hardwire electrical power source 156 to charge and provide electrical power to the wireless headphones device 100. The radio tuner 120, the volume control button 130, the display screen 140 and the recharging port 150 are disposed on the exterior cover portion 112 of the right headphone 110. The headband 160 has an inside surface 162 and adjustably places the wireless headphones device 100 over the user's head and is further described and illustrated in FIG. 1B and its description. The first pads 170 are disposed on the interior portion 114 of the right headphone 110 and the inside surface 162 of the headband 160 to provide comfort to the user while wearing the wireless headphones device 100.

FIG. 1B illustrates a left side view of a wireless headphones device 100, according to an embodiment of the present invention. More specifically, FIG. 1B illustrates a left headphone 180 of the wireless headphones device 100.

The left headphone 180 has an exterior cover portion 182 and an interior portion 184 and includes a SD card insert 186, a second plurality of pads 188 and a plurality of control buttons 190. The SD card insert 186 is disposed on the exterior cover portion 182 of the left headphone 180 and receives an SD card (not shown) that one or more music files reside on. The second plurality of pads 188 is disposed on the interior portion 184 of the left headphone 180 to provide comfort to the user while wearing the wireless headphones device 100. The control buttons 190 include a play forward button 191, a play button 192, a rewind button 193, a pause button 194 and a stop button 195. The SD card insert 186 and the control buttons 190 are disposed on the exterior cover portion 182 of the left headphone 180. The play forward button 191 allows the user to move forward on the music file being played that resides on the SD card. The play button 192 is depressed when the user desires to play the music being played that resides on the SD card. The rewind button 193 allows the user to move backwards on the music file being played that resides on the SD card. The pause button 194 allows the user to pause music being played on the music file being played that resides on the SD card. The stop button 195 allows the user to stop music being played on the music file being played that resides on the SD card.

The wireless headphones device is typically made of solid plastic and is capable of playing MP3's without a need for a handheld music player and is a relatively better wireless headphones device in comparison to a traditional wireless headphones device. On an exterior portion of a first headphone, the wireless headphones device contains an SD port allowing a user to relatively easily insert an SD card housing one or more files, along with a plurality of standard buttons that include a volume control button, a play forward button, a play button, a forward button, a rewind button, a pause button and a stop button in order to navigate operating the wireless headphones device. Located on an exterior portion of a second headphone of the wireless headphones device is an AM/FM or other suitable radio, a display screen which indicates a current radio station and a plurality of tuning buttons. Among those who will find the wireless headphones device both relatively practical and easy to use are electronics manufacturing companies as well as an everyday user. The wireless headphones device features headphones capable of reading an SD card which can be charged through a recharging port located on an ear cover containing the AM/FM or other suitable radio. The first headphone, the second headphone and a headband of the wireless headphones device are padded with one or more relatively soft cushions to enhance a user's comfort.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A wireless headphones device utilized by a user with a head, comprising:
a right headphone that has an exterior cover portion and an interior portion and includes a radio tuner, a volume control button, a display screen, a recharging port, a headband and a first plurality of pads; and
a left headphone that has an exterior cover portion and an interior portion and includes a SD card insert, a second plurality of pads and a plurality of control buttons, wherein said headband has an inside surface and adjustably places said wireless headphones device over said user's head.

2. The device according to claim 1, wherein said radio tuner selects one or more predetermined radio stations.

3. The device according to claim 2, wherein said one or more predetermined radio stations is a satellite radio station.

4. The device according to claim 2, wherein said one or more predetermined radio stations is an AM/FM radio station.

5. The device according to claim 2, wherein said display screen indicates said predetermined radio station selected by said wireless headphones device.

6. The device according to claim 1, wherein said volume control button controls a plurality of predetermined volume levels of music emitted from said wireless headphones device.

7. The device according to claim 1, wherein said display screen is a digital display screen.

8. The device according to claim 7, wherein said display screen is an LED display screen.

9. The device according to claim 1, wherein said recharging port receives an input jack from an external electrical power source to charge and provide electrical power to said wireless headphones device.

10. The device according to claim 9, wherein said external electrical power source is a battery.

11. The device according to claim 9, wherein said external electrical power source is a hardwire electrical power source.

12. The device according to claim 1, wherein said radio tuner, said volume control button, said display screen and said recharging port are disposed on said exterior cover portion of said right headphone.

13. The device according to claim 1, wherein said first pads are disposed on said interior portion of said right headphone and said inside surface of said headband to provide comfort to said user while wearing said wireless headphones device.

14. The device according to claim 1, wherein said second plurality of pads is disposed on said interior portion of said left headphone to provide comfort to said user while wearing said wireless headphones device.

15. The device according to claim 1, wherein said SD card insert and said control buttons are disposed on said exterior cover portion of said left headphone.

16. The device according to claim 1, wherein said control buttons include a play forward button, a play button, a rewind button, a pause button and a stop button.

17. The device according to claim 16, wherein said play forward button allows said user to move forward music on a music file being played that resides on said SD card.

18. The device according to claim 16, wherein said rewind button allows said user to move backwards on said music file being played that resides on said SD card and said pause button allows said user to pause said music being played on said music file being played that resides on said SD card.

19. The device according to claim 16, wherein said stop button allows said user to stop said music being played on said music file being played that resides on said SD card.

20. The device according to claim 16, wherein said play button is depressed when said user desires to play said music being played that resides on said SD card.
